(19) United States
(12) Patent Application Publication
(10) Pub. No.: US 2008/0159074 A1
(43) Pub. Date: Jul. 3, 2008

(54) SYSTEM AND METHOD FOR QUALITY CONTROL OF NOISY DATA

(75) Inventor: Vincente H. Guis, Marseille (FR)

Correspondence Address: CANTOR COLBURN LLP- BAKER ATLAS, 20 Church Street, 22nd Floor, Hartford, CT, 06103, US

(73) Assignee: MAGNITUDE SPAS, Sainte Tulle (FR)

(21) Appl. No.: 11/959,002

(22) Filed: Dec. 18, 2007

Related U.S. Application Data
(60) Provisional application No. 60/882,004, filed on Dec. 27, 2006.

(51) Int. Cl. G01V 1/36

(52) U.S. Cl. 367/40

(57) ABSTRACT

Disclosed is a method for evaluating seismic data, the method including identifying seismic data sets which are homogeneous; and identifying noise in the data sets by at least one of performing a macro analysis of the data sets to identify noise components; performing a correlation analysis of the data sets to identify correlating noise data; performing a polarization analysis to identify a direction of noise; and performing a spectral analysis to identify frequencies associated with noise. An associated system and computer program product are provided.

### BACKGROUND OF THE INVENTION

1. Field of the Invention

The teachings herein relate to seismic monitoring, and in particular, to limiting noise effects in seismic data.

2. Description of the Related Art

Sensors are provided for a variety of applications and permit the recording of physical features in electronic format. There are a wide variety of sensors that sense a wide variety of characteristics. Some sensors are sensitive to a single physical change, such as a voltmeter, which detects the electrical potential between two points. Other sensors are sensitive to several physical changes, such as some photoelectric sensors whose response also degrades with increased temperature.

Sensing technology has long faced the challenge of discerning a data signal in the presence of noise. “Noise” as described herein refers to unwanted components of a data signal. Noise generally results from a source other than the physical feature to be measured. Some noise, referred to herein as “random noise”, is natural and to be expected in any sensitive system. For example, tuning a radio to a spot between two stations may produce white noise, or static. This random noise is the result of natural phenomena, but are not the signals in which a user is generally interested. Other noise, referred to herein as “sourced noise”, comes from specific sources. For example, when tuning an AM radio near a high-tension power line, an increase in noise or static will result from the proximity to the power line. Random noise generally cannot be eliminated. However, sourced noise, if it can be identified, can be eliminated or minimized. Elimination of the sourced noise results in reduction in the total noise and in turn a better signal-to-noise ratio.

Sensors may be used for monitoring aspects of subterranean formations. Exemplary sensors include, or may be incorporated in, one or more seismic receivers. Such receivers may be geophones placed at the surface or submerged in wellbores or on the ocean floor. Also, the receivers may be hydrophones placed in those same locations, but sensitive to only certain types of waves. The receivers placed in wellbores may be shallow (usually above the formation of interest) or deep (usually at or below the formation of interest). Seismic receivers may be sensitive to seismic waves along a certain axis or those traveling on any axis. Likewise, the receivers may be sensitive to only certain types of seismic waves, or several types. Those sensitive to certain axes of travel, called directional receivers, may be coupled with other directional receivers. For example, a directional receiver may be coupled with two other directional receivers in a set of three orthogonal receivers which collect information about the waves in three dimensions. This three-dimensional information may be rotated mathematically through the use of trigonometric functions in order to derive information as to wave travel in the x-axis, y-axis, and z-axis relative to gravity. Alternatively, mathematical rotation may provide translation of the data relative to a wellbore, a cardinal direction, or any other reference point.

Microseismic monitoring concerns passively monitoring a formation for seismic events which are very small. Such events may include the seismic effects generated in a formation by fracturing, depletion, flooding, treatment, fault movement, collapse, water breakthrough, compaction or other similar subterranean interventions or effects. One of the main problems with microseismic monitoring, as with other forms of seismic monitoring, is that of noise.

With microseismic events, the problem of noise is emphasized because the signal strength is generally very small. This means, in turn, that a small amount of noise which would not cause any significant effect as to a regular, active seismic survey causes a significant degradation of the signal-to-noise ratio in the microseismic survey. Therefore, the identification of the source of sourced noise may permit greatly enhanced monitoring capabilities. For example, if it can be identified that noise is generated due to a faulty receiver, that receiver may be replaced. Similarly, if it can be identified that the noise is from a pump on site, that sourced noise may be filtered.

Microseismic data may be analyzed as a set, with several receivers providing data for a joint analysis. Data is collected from a receiver and related to other data collected from other receivers in order to derive additional information about the formation. Information from three receivers, for example, may be triangulated in order to estimate the location of a seismic event.

What are needed are systems and methods for performing quality control checks on noise data in order to distinguish random noise from sourced noise, permitting the elimination or reduction of the sourced noise.

### SUMMARY OF THE INVENTION

Disclosed is a method for evaluating seismic data, that includes: identifying seismic data sets which are homogeneous; and identifying noise in the data sets by at least one of performing a macro analysis of the data sets to identify noise components; performing a correlation analysis of the data sets to identify correlating noise data; performing a polarization analysis to identify a direction of noise; and performing a spectral analysis to identify frequencies associated with noise.

Also disclosed is a system for evaluating seismic data, that includes: at least one seismic receiver for outputting seismic data; and a processing unit for inputting the seismic data and implementing instructions for evaluating seismic data by identifying seismic data sets which are homogeneous; and identifying noise in the data sets by at least one of performing a macro analysis of the data sets to identify noise components; performing a correlation analysis of the data sets to identify correlating noise data; performing a polarization analysis to identify a direction of noise; and performing a spectral analysis to identify frequencies associated with noise.

Further, a computer program product is provided for evaluating seismic data by executing machine implemented instructions, the instructions for: identifying data sets which are generated from seismic channels that include at least one common characteristic; and identifying noise in the data sets by at least one of performing a macro analysis of the data sets to identify noise components; performing a correlation analysis of the data sets to identify correlating noise data; performing a polarization analysis to identify a direction of noise; and performing a spectral analysis to identify frequencies associated with noise.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a seismic monitoring system;

FIG. 2 is a flow chart providing an exemplary method for identifying noise in seismic data; and

FIG. 3 and FIG. 4 depict exemplary displays of correlation data.

### DETAILED DESCRIPTION OF THE INVENTION

Subterranean formations are of interest for a variety of reasons. Such formations may be used for the production of hydrocarbons, the storage of hydrocarbons or other substances, mining operations or a variety of other uses. One method used to obtain information regarding subterranean formations is to use acoustic or seismic waves to interrogate the formation. Seismic waves may be generated into the formation and the resulting reflected waves received and analyzed in order to provide information about the geology of the formation. Such interrogations are referred to as active seismic surveys. As described herein, a “formation” may be defined as any subsurface material and/or volume that is targeted for seismic monitoring, or is otherwise subject to evaluation.

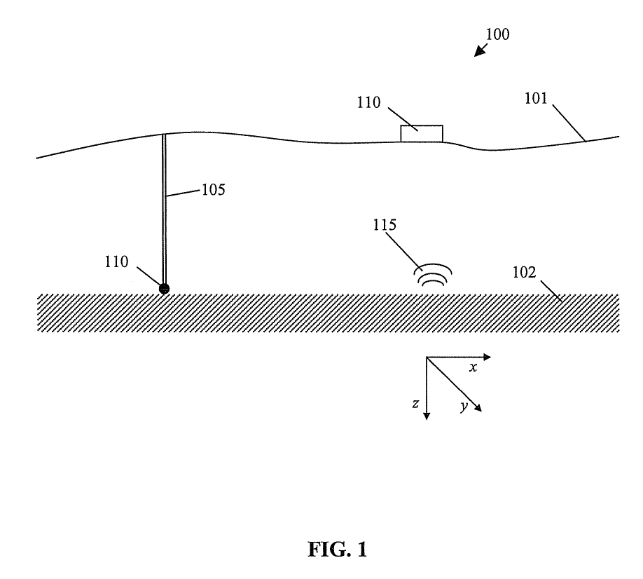

Referring to FIG. 1, there is provided a system 100 for seismic monitoring. The system 100 includes a plurality of seismic receivers 110. A first receiver 110 is disposed within a wellbore 105, and a second receiver 110 is disposed on a surface 101. Each of the receivers 110 provides for monitoring of seismic activity in or around a formation 102. When seismic activity occurs, seismic waves 115 are generated. Each receiver is adapted to detect seismic signals in the form of, for example, waves 115, and generate seismic data indicative of the waves 115. Thus, the receivers 110 provide indications of seismic activity. Although two receivers 110 are shown, any number of receivers 110, located on the surface 101 or at any location in a geology, may be included in the network 100.

One or more subterranean formations 102 may be monitored using one or more of the seismic receivers 110, each of which are adapted for operation to receive seismic waves 115 generated by seismic activity and generate seismic data therefrom. In one embodiment, the receivers 110 are passive seismic receivers. Each receiver 110 may be a geophone and/or a hydrophone placed at the surface 101, submerged in wellbores, such as wellbore 105, or on the ocean floor. Other types of receivers 110 known now or in the future may also be used. The receivers 110 may be placed in shallow wellbores 105 (usually above the formation of interest), deep wellbores 105 (usually at or below the formation of interest) or at the surface 101. The receivers 110 may be sensitive to seismic waves 115 along a certain axis or those traveling on any axis. Likewise, the receivers 110 may be sensitive to only certain types of seismic waves 115, or several types. Those sensitive to certain axes of travel, referred to as directional receivers 110, may be coupled with other directional receivers 110. For example, a directional receiver 110 may be coupled with two other directional receivers 110 in a set of three orthogonal receivers 110 which collect information about the waves 115 in three dimensions. This three-dimensional information may be rotated mathematically through the use of trigonometric functions in order to derive information as to wave travel in the x-axis, y-axis, and z-axis relative to gravity. Alternatively, mathematical rotation may provide translation of the data relative to the wellbore 105, a cardinal direction, or any other reference point.

The receivers 110 may be analog or digital. Analog receivers 110 generally provide only an analog signal of the reading achieved by the receiver 110. Digital receivers 110, by contrast, provide a digital signal and may provide several other self-diagnostic features. Examples of these self-diagnostic features may include a self-test mode, where a known signal is generated as input to the digital circuit for comparison to the output signal. From this test, the receiver 110 may be able to provide effective response measurements, electronic noise measurements, synchronization, effective digitization and other pertinent data. However, even digital receivers 110 may not effectively test the entire system 100. For example, coupling issues between the receiver 110 and the formation 102 may remain uncharacterized.

Each receiver 110 is adapted to detect seismic signals, for example in the form of seismic or acoustic waves 115, and generate a stream of seismic data indicative of the waves 115. Seismic data may include data regarding seismic events and data that is considered noise. Each stream of seismic data includes a plurality of data points generated by a respective receiver 110 during a selected duration of time or time window. The plurality of data points from a single receiver 110 over the selected duration of time or time window is referred to as a “trace”. These data points may also be referred to as a “trace data stream”. A “data set” for a receiver 110 may refer to a plurality of data points in the trace over any selected time period. Each “data set” or “trace” may be divided into one or more “subsets”, which refer to a fraction of the data set over a selected fraction of the time period of the trace. In one embodiment, each of the plurality of data points represents an amplitude of the wave 115 received by the receiver 110 at a certain time in the time window.

The network 100 used to detect the seismic signals may include any number of receivers 110, and can be quite large. In one embodiment, each receiver location may record data from multiple receivers. For example, multiple receivers 110 may be placed in a single location so that data may be recorded from multiple receivers 110. Thus, the terms “receiver” and “receiver location” may analogously denote a location that may generate one or more traces. In another example, receivers 110 that are sensitive to x-axis, y-axis, or z-axis directions may be disposed in a single location to record seismic events or activity. In such an example, three or more traces may be generated from each single location. Each individual receiver or sensor that generates a single trace may also be referred to as a “channel”. Monitoring of an entire network, which may consist of tens or hundreds of sensing locations, may generate a large number of traces.

One or more of the receivers 110 may be connected to a computer, processor or other device adapted to receive seismic data (or data from the receiver 110 is provided to a computer) for analysis. The system 100 may further include analysis equipment, memory devices or systems, power sources, timers, support equipment for operation of the receivers 110, or any other components for generating, receiving, storing or analyzing seismic data.

The system 100 may be used in seismic monitoring of a geology. One example of seismic monitoring is microseismic monitoring, which concerns passively monitoring the formation 102 for seismic events which are very small. In passive monitoring, the formation 102 is not interrogated, per se, but the seismic receivers 110 are placed to receive directly any seismic waves 115 generated by events occurring within the formation 102. Such events may include the seismic effects generated in a formation 102 by fracturing, depletion, flooding, treatment, fault movement, collapse, water breakthrough, compaction or other similar subterranean interventions or effects. This additional information about these events may be very useful in order to enhance the use of the formation 102 or provide additional safety measures in certain situations. For example, it is common in the hydrocarbon production industry to fracture or “frac” a formation 102. During this operation, fluid and propant is pumped down a wellbore, such as wellbore 105, at high pressure in order to generate additional fracturing within a zone of the wellbore. The propant is pumped into these fractures and maintains them after the pressure is removed. Monitoring the seismic waves generated during and immediately after a frac operation can provide critical information about the operation, such as the direction and extent of the fractures being generated.

In yet another exemplary application, microseismic monitoring may be used to provide long-term monitoring for subterranean storage facilities and formations 102 from which hydrocarbons or water is being produced. Under certain conditions, the integrity of these formations 102 may become compromised, causing collapse. Such collapses may pose a safety concern for those on the surface, as entire sections of ground may fall into the collapse. However, often certain characteristic small seismic waves 115 may precede such failures, permitting remedial measures to delay the collapse and ultimately some warning of the impending collapse to allow for isolation of any dangerous areas from personnel.

In practice, however, identification of these very small seismic waves 115 is made more difficult by the presence of noise. Certain noise, referred to as “random noise”, is the result of random natural phenomena. As it is random and not predictable, random noise generally may not be effectively filtered from a data set except by methods that include thresholding. Other noise, however, referred to as “sourced noise”, results from a certain source. Sourced noise may be eliminated either by removing or attenuating the source or by filtering the effects of the sourced noise from a data set. Reduction of the sourced noise reduces the total noise and therefore improves the signal-to-noise ratio available to detect seismic events, such as microseismic events.

The seismic waves 115 of interest for microseismic monitoring are generally of very small amplitude. Accordingly, a small amount of noise may cause a significant degradation of the signal-to-noise ratio in the microseismic survey. It has been discovered, however, that analyzing several sets of seismic waves 115 which have a very poor signal-to-noise ratio yields useful information which allows identification of sourced noises. Identification of these sourced noises permits their filtering and accordingly a reduction in the overall noise level. In turn, the signal-to-noise ratio may be improved.

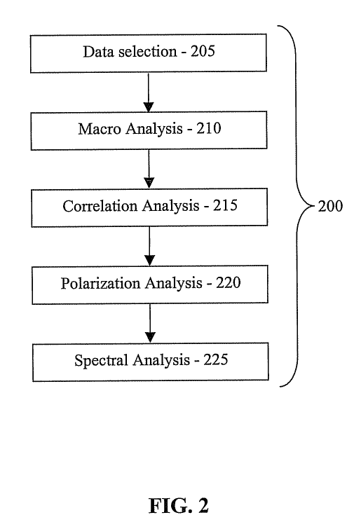

FIG. 2 illustrates a method 200 for identifying noise contained in the recorded seismic signals, which may be utilized in, but is not limited to, microseismic passive monitoring. The method 200 includes one or more stages 205, 210, 215, 220 and 225. The method 200 is described herein in conjunction with the plurality of receivers 110, although the method 200 may be performed in conjunction with any number and configuration of receivers. The method 200 may be performed by one or more processors or other devices capable of processing seismic data. In one embodiment, the method includes the execution of all of stages 205, 210, 215, 220 and 225 in the order described. However, certain stages may be omitted, stages may be added, or the order of the stages changed.

In the first stage 205, data selection is performed. Data selection is the process of identifying data sets, such as microseismic data sets, which are homogeneous. Homogenous data sets are data sets generated from a plurality of common receivers 110. “Common receivers”, as described herein, refers to a plurality of receivers 110 or channels, each of which share at least one common characteristic or commonality.

Commonalities among a plurality of receivers 110 may be sought and the information common to them may be collected. For example, several receivers 110 in the same geographical area may be subject to the same weather patterns, and this information regarding the common weather patterns may be collected. Similarly, information on the data network, i.e., plurality of receivers 110, may be collected and tagged, including information such as common servers which are collecting information from the receivers 110, receivers 110 located in the same drilled wellbore 105, receivers 110 placed at the same location but sensitive to different directional seismic waves, receivers 110 made by the same manufacturer, receivers 110 that are all proximate to nearby known noise sources (e.g., roads, pumps, etc.), receivers 110 whose information is collected by a certain method (e.g., wirelessly, via fiber optics, via copper wire, etc.) and the like. Through this information, common characteristics among groups of receivers 110 may be noted, so that the data sets from such groups of receivers 110 may be analyzed to identify sources of noise.

In the second stage 210, the homogenous data sets may be analyzed using macro analysis. Macro analysis may include at least one of high resolution and low resolution analysis.

In one embodiment, low resolution macro analysis is performed on raw data sets or traces from the common receivers 110, to observe similarities between the raw data sets and certain milestones found from the data selection process. Such milestones may include selected time periods from the raw data and selected waveforms from the raw data. Low resolution macro analysis may be automated.

In one embodiment, low resolution macro analysis highlights for an operator limits in data curves from each trace in order to isolate subsets of the data. A subset may be a selected portion of the trace from a receiver 110, which may include data in the trace from a single receiver 110 over a selected time period. Limits may be calculated for various subsets of the data based on a statistical analysis of each subset, which may be performed in several ways.

In one embodiment, a subset of the trace is fit to a selected curve. The fit between the subset and the selected curve may include a number of fit points between the subset and the curve, which may be, for example, a point, an angle, and/or a curvature. For example, each subset may be fit with a Gaussian curve. The fit is attempted iteratively for each subset throughout the data set. A lack of fit (for example, a number of fit points being less than a threshold number) may indicate a limit for the respective subset. Examples of data fitting include various regression methods, such as linear regression, least squares, segmented regression, hierarchal linear modeling, and others.

In another embodiment, the mean of the data set (which may include both random noise and sourced noise) recorded by the receiver during a finite time may be observed for a subset, with changes in the mean relative to the other subsets of the data set indicating a limit. For example, a limit may be identified for a subset having a mean that exceeds a selected energy level threshold. The energy level threshold may be based on the mean of one or more subsets, and/or may be based on statistical attributes of the means of the subsets, such as an average or a standard deviation. In yet another embodiment, statistical attributes for each subset may be calculated, such as a standard deviation for each subset, with readings outside a selected range or above a selected threshold of the standard deviation triggering a limit determination.

Each limit calculated may be flagged for the operator or otherwise noted or recorded. In one embodiment, a combination of several such techniques may be used in order to automatically detect several types of limits. Identification of limits may be performed manually, or a computer or other processing device may perform such processing either on site or at a central processing location or other location.

Once the low resolution limits are detected, comparison of the limits is made to the event logs for each receiver 110 located during the data selection process. Similarities suggest an effect of the event on the data set. Accordingly, that event may be filtered or the data for that time period discarded in order to reduce the noise in the overall data set from the several receivers 110.

In the third stage 215, high resolution analysis may be performed on the homogeneous data sets. The high resolution analysis may include, for example, cross-correlation analysis, and comparison of various statistical attributes of each channel. Such statistical attributes may include, for example, a summation, an average, a variance, a standard deviation, t-distribution, a confidence interval, and others.

A cross-correlation coefficient is computed for data sets from each selected pair of channels, e.g., receivers 110, selected, such as channels having selected common characteristics. The results of this analysis, i.e., the computed coefficients for each pair, may be plotted according to channel, with each channel representing the data from a receiver 110. By grouping channels logically on the plot, correlations become readily apparent. For example, by grouping channels representative of x-axis readings, y-axis readings, and z-axis readings together, correlations between the various axes become apparent. Similarly, the grouping of the channels may be rearranged within the same analysis to detect other similarities (e.g., grouping locations or servers or the like). Points of high correlation (noted as lighter shades on the figures) suggest sourced noise, rather than random noise. In theory, random noise should present no correlation at all between various channels.

In one embodiment, evolution of time at each channel may be computed. In one example, an offset consistency between selected channels may be computed. An offset consistency between all channels at a location may indicate an electrical grounding problem. In another example, a standard deviation of the data received for each location may be computed to locate wellbore-by-wellbore discrepancies.

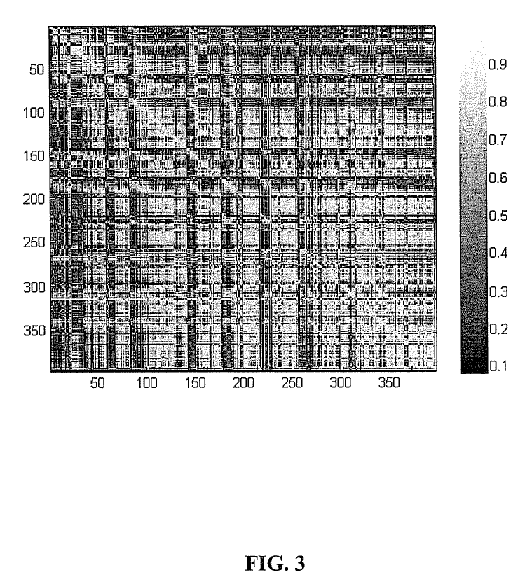

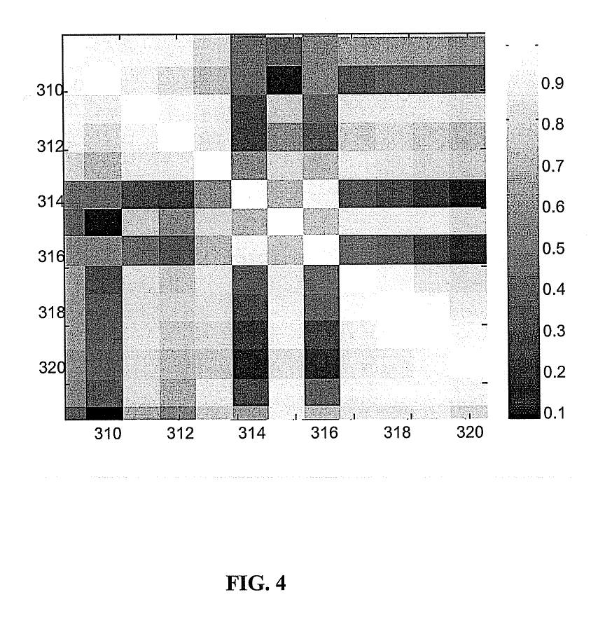

Referring to FIGS. 3 and 4, examples of cross-correlation charts are shown, which illustrates cross-correlation coefficients among a plurality of channels numbered 1-400. Correlations between pairs of channels are shown in varying shades, with lighter shades indicating higher correlations and darker shades indicating lower correlations. FIG. 3, for example, demonstrates a cross-correlation chart for channels 1-400 that shows a cross-hatch pattern. FIG. 4, for example, shows additional patterns represented by three-by-three blocks. For example, one of the blocks shows high correlations among channels 311-313, and another block shows high correlations among receivers 317-319.

In one embodiment, plots of the cross-correlation may be provided by color. For example, red may indicate a high correlation, and thus problematic data. In another example, a low correlation is indicated with another color, such as blue, which may indicate random noise. As shown in FIGS. 3 and 4, variations in correlation may be shown in a continuum of colors and/or shades.

Referring again to FIG. 2, data having a high correlation coefficient may be removed or filtered. For example, a subset of data from each of a pair of channels having a correlation coefficient above a selected threshold may be removed from the data sets for the respective channels. In one embodiment, the cross-correlation charts may be used to identify patterns of high correlation and filter or remove selected high correlation data.

In another embodiment, the computed correlation coefficients may be used to process seismic data iteratively. For example, data from selected channels may be cross-correlated, and once an item of high correlation has been isolated, it may be filtered or removed. The remaining data may again be cross-correlated in the same manner to reveal any additional areas of high correlation that may also be filtered or removed. This process may repeat until all of the data remaining is random noise.

In one embodiment, the identification of causation in cross-correlations may be automated using various pattern recognition techniques. For example, correlations between all of the channels from one direction may produce one identifiable pattern (cross-hatching, such as is shown in the example of FIG. 3), while correlations between three channels at a given location may produce another identifiable pattern (a three-by-three block, such as is shown in the example of FIG. 4). It will be appreciated by ordering the cross-correlation chart in different manners, different patterns will be appreciated, some of which may be subject to easier recognition (such as the three-by-three block of high correlation) than other configurations (such as the cross-hatching pattern). In one embodiment, several permutations of channel configurations on the chart may be utilized in order to effectively recognize correlation patterns and otherwise analyze, manually or automatically, the data for sourced noise.

The results of the cross-correlation analysis may be compared to and used with the results of the macro analysis. Accordingly, information derived from the cross-correlation analysis may be used to identify consistencies with events identified from the macro analysis. For example, high correlation values may be computed for a selected group of channels (e.g., channels in a selected geologic area) in a certain time window, which may be compared with the results of the macro analysis. Thus, if limits are identified for the group of channels in the same time window, the macro analysis may thus confirm the existence of sourced noise indicated by the correlation analysis. Similarly, cross-correlations of different time periods may be computed and compared against the macro analysis in order to provide similar correlations to identify which noise is sourced noise.

In one embodiment, the correlation analysis may include regression analysis of the data received from each channel. For example, a standard deviation value may be calculated for a particular sensor or channel over a selected period of time. In one embodiment, the mean of the standard deviation values for each period of time for a single channel may be calculated, resulting in a mean value for each sensor or channel. It may be expected that half of the total number of sensors will have mean values that are greater than the standard deviation of the total mean values of the sensors. Plotting the mean of the mean values may show spikes indicative of sourced noise. Plotting the standard deviation of the mean values may show the variation of the spikes, allowing the spotting of consistency in the spikes which can then be used to isolate sourced noise.

In one embodiment, for each set of sensors, the mean noise level and the standard deviation over a period of time may be computed for each channel. High correlation for all channels at a certain time may suggest that a cross-correlation /regression analysis for that time period would be faulty. This data should be removed before the cross-correlation/regression analysis described above. In one embodiment, the channels associated with this data may be sorted, for example from most stable to least stable, to allow selection of the largest number of noise issues, so that those channels may be selectively discarded from computation.

In one embodiment, if the data from a channel is highly Gaussian, regression analysis using the standard deviation and the mean is used. In another embodiment, various forms of probability distributions, such as chi-squared or gamma distribution, may be used. In yet another embodiment, such distributions may be used if the data from a channel is not highly Gaussian.

In the fourth stage 220, a polarization analysis may be performed. If sensors are arranged to be sensitive to certain axes, the direction of noise data with reference to selected planes (e.g. the x-y plane) may be computed, to identify the existence of sourced noise. The azimuth and/or inclination of the signal from each channel may be calculated. For random noise, it may be expected that no specific direction of noise, and thus no pattern, would be detected. Patterns may be detected to suggest sourced noise, which may then be removed or otherwise filtered.

In one embodiment, the azimuth and inclination of the signals may be plotted using polar coordinates to allow for automatic or manual identification of non-uniform patterns in expected noise. The azimuth and inclination may be plotted, for example, with a color or shading to denote the intensity or energy in various directions. These non-uniform patterns may suggest sourced noise and may also suggest a direction from which the noise emanates, which may assist in the construction of a filter for the sourced noise. Particularly polarized noise may suggest the application of a polarization filter. In one embodiment, the axes to which sensors are sensitive may be trigonometrically rotated, as necessary, to provide for polar plots along one or more selected planes. In some embodiments, sensors sensitive to a single axis may be placed orthogonally, yielding for example x-axis, y-axis, and z-axis readings which need not necessarily be rotated.

In a fourth stage 225, a spectral analysis is performed on the data received from the common receivers. Spectral analysis, i.e., spectral estimation, allows correlations to be observed based on frequency. Spectral estimation describes the distribution (over frequency) of the power contained in a signal within a finite set of data, such as within a selected time period. Analysis based on frequency using the foregoing methods (e.g., macro analysis, correlation analysis and polarization analysis) may reveal certain frequencies in which noise occurs more frequently, suggesting that signals at such frequencies may be sourced noise. Identification of source noise at certain frequencies may help to identify the source of the noise. For example, it has been observed that noise consistently within the 50 Hz range occurs when there are electrical degradation issues due to faulty insulation and the like. Imaging may be used to more easily identify shifts in frequency between several channels, which may be indicative of wiring problems, as one would expect equal sensor response to random noise. Spectral analysis may be used to suggest filters that should be applied to the data in order to remove sourced noise results. Accordingly, any suitable filters known now or in the future, such as band pass filters and cutoff filters, may be used as suggested by the results of the spectral analysis.

The systems and associated methods described herein may be used to process data in real-time or near real-time in order to provide timely information to personnel at the site of the formation. “Real-time” data may refer to data transmitted to the collection machine upon or shortly after detection and/or recordation by one or more receivers 110. This information may then be used in order to influence interventions or to provide additional safety measures, as previously described.

In one embodiment, the method is embodied in a system comprising a dense field of receivers 110, so that a plurality of locations may be compared to detect variances. A less dense field may use the same methodology, but reliability may be reduced accordingly, as it is the variations in values calculated for the locations that provide indications of an event. Fewer data sets may provide a less reliable baseline from which to operate.

Additionally, at least one program storage device readable by a machine, tangibly embodying at least one program of instructions executable by the machine to perform the method 200 may be provided. In one embodiment, the method 200 is performed by a processor or other processing machine.

The systems and methods described herein provide various advantages over existing seismic monitoring systems. The systems and methods described herein allow for accurate identification of sourced noise to ascertain identifiable sources of noise, and so that seismic data may be analyzed to accurately detect seismic events. The systems and methods described herein also provide seismic event and sourced noise information in a very timely manner, so that interventions may be undertaken immediately as suggested by the sourced noise and/or events.

In support of the teachings herein, various analysis components may be used, including digital and/or analog systems. The devices, systems and methods described herein may be implemented in software, firmware, hardware or any combination thereof. The devices may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the devices and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure. The computer executable instructions may be included as part of a computer system or provided separately.

Further, various other components may be included and called upon for providing for aspects of the teachings herein. For example, a pump, piston, power supply (e.g., at least one of a generator, a remote supply and a battery), motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for evaluating seismic data, the method comprising:
identifying seismic data sets which are homogeneous; and
identifying noise in the data sets by at least one of:
performing a macro analysis of the data sets to identify noise components;
performing a correlation analysis of the data sets to identify correlating noise data;
performing a polarization analysis to identify a direction of noise; and
performing a spectral analysis to identify frequencies associated with noise.

2. The method of claim 1, wherein the seismic data sets are data sets from a plurality of seismic channels, each of the seismic channels including at least one common characteristic.

3. The method of claim 1, further comprising removing the noise from the data sets.

4. The method of claim 1, wherein performing the macro analysis comprises analyzing a plurality of subsets of each of the data sets to identify a limit for at least one subset.

5. The method of claim 4, wherein the limit is identified by at least one of: i) performing a fit of each of the plurality of subsets to a selected curve, ii) computing a mean energy level for each subset and comparing the mean energy level to an energy level threshold, and iii) computing a statistical attribute of each of the plurality of subsets and comparing the statistical attribute to a threshold.

6. The method of claim 4, further comprising comparing the limit to the plurality of data sets to identify the noise.

7. The method of claim 1, wherein performing the correlation analysis comprises at least one of: performing cross-correlation analysis and comparing at least one statistical attribute of the data sets.

8. The method of claim 7, wherein performing the cross-correlation analysis comprises computing a cross-correlation coefficient for at least one pair of the data sets, and identifying the noise based on the cross-correlation coefficient.

9. The method of claim 8, wherein performing the cross-correlation analysis comprises displaying the cross-correlation coefficient.

10. The method of claim 8, wherein performing the cross-correlation analysis comprises removing one or more pairs having the cross-correlation coefficient that is greater than a coefficient threshold.

11. The method of claim 1, wherein performing the polarization analysis comprises:
computing a value for each data set,
computing an angle of each data set from at least one of an azimuth and an inclination of a signal corresponding to each data set, and
identifying the noise based on one or more patterns of the value for each data set relative to the angle.

12. The method of claim 11, wherein identifying the noise comprises plotting the value and the angle of each data set on a display, and observing the one or more patterns therefrom.

13. The method of claim 1, wherein each data set comprises a power distribution of a seismic signal over a frequency range.

14. The method of claim 13, wherein performing the spectral analysis comprises identifying frequencies of the noise based on frequencies associated with a power value above a power threshold.

15. The method of claim 2, wherein removing the noise comprises at least one of filtering the noise, removing at least one subset of the data sets, and removing a source of the noise.

16. The method of claim 1, wherein the data sets comprise at least one of real-time data and near real-time data.

17. A system for evaluating seismic data, the system comprising:
at least one seismic receiver for outputting seismic data; and
a processing unit for inputting the seismic data and implementing instructions for evaluating seismic data by:
identifying seismic data sets which are homogeneous; and
identifying noise in the data sets by at least one of:
performing a macro analysis of the data sets to identify noise components;
performing a correlation analysis of the data sets to identify correlating noise data;
performing a polarization analysis to identify a direction of noise; and
performing a spectral analysis to identify frequencies associated with noise.

18. The system of claim 17, wherein the at least one seismic receiver is disposed in a location selected from at least one of a surface location, and a location within a wellbore.

19. The system of claim 17, wherein the at least one seismic receiver comprises a plurality of channels, and the homogeneous data sets are generated from channels that include at least one common characteristic

20. A computer program product stored on machine readable media for evaluating seismic data by executing machine implemented instructions, the instructions for:
identifying data sets which are generated from seismic channels that include at least one common characteristic; and
identifying noise in the data sets by at least one of:
performing a macro analysis of the data sets to identify noise components;
performing a correlation analysis of the data sets to identify correlating noise data;
performing a polarization analysis to identify a direction of noise; and
performing a spectral analysis to identify frequencies associated with noise.
